(19) United States
(12) Patent Application Publication
(10) Pub. No.: US 2024/0391354 A1
(43) Pub. Date: Nov. 28, 2024

(54) MODULE BALANCING FOR A MIXED CHEMISTRY BATTERY

(71) Applicant: GM GLOBAL TECHNOLOGY OPERATIONS LLC, DETROIT, MI (US)

(72) Inventors: Zhenwen Hu, Shanghai (CN); Chengwu Duan, Shanghai (CN); Jian Yao, Shanghai (CN); Yue-Yun Wang, Troy, MI (US); Chandra S. Namuduri, Troy, MI (US)

(21) Appl. No.: 18/363,867

(22) Filed: Aug. 2, 2023

(30) Foreign Application Priority Data
May 24, 2023 (CN) 202310592163.2

(51) Int. Cl. B60L 58/22; B60L 58/12; H01M 10/44; H01M 10/46; H02J 7/00

(52) U.S. Cl. CPC B60L 58/22; B60L 58/12; H01M 10/441; H01M 10/46; H02J 7/0016; H02J 7/0048; H01M 2220/20

(57) ABSTRACT

Embodiments include balancing modules during charging of a mixed chemistry battery pack having a first battery module connected in series to a second battery module. Aspects include monitoring a first state-of-charge (SOC) of the first battery module having a first battery chemistry and monitoring a second SOC of the second battery module having a second battery chemistry. Aspects also include selectively activating one of a first bypass switch and a first activation switch of the first battery module based on the first SOC and the second SOC and selectively activating one of a second bypass switch and a second activation switch of the second battery module based on the first SOC and the second SOC. The activation of the first bypass switch prevents the first battery module from charging and activation of the second bypass switch prevents the second battery module from charging.

### CROSS-REFERENCE TO RELATED APPLICATIONS

This application claims priority to Chinese Patent Application No. 202310592163.2, filed May 24, 2023, and all the benefits accruing therefrom under 35 U.S.C. § 119, the contents of which in its entirety are herein incorporated by reference.

### INTRODUCTION

The disclosure relates to mixed chemistry batteries. More specifically, the disclosure relates to module balancing for a mixed chemistry battery.

Lithium-ion batteries are used in a variety of applications, from electric vehicles to residential batteries to grid-scale applications. In general, the term lithium-ion battery refers to a wide array of battery chemistries that each charge and discharge using reactions from a lithiated metal oxide cathode and a graphite anode. As used herein, a mixed chemistry battery is a lithium-ion battery that includes battery cells that have at least two different chemistries. Two of the more commonly used lithium-ion chemistries are nickel manganese cobalt (NCM) and lithium iron phosphate (LFP). In general, LFP batteries are less expensive to manufacture than NCM batteries and NCM batteries have higher power ratings and energy density compared to LFP batteries.

In general, charge imbalances between battery modules of a mixed chemistry battery reduce the useable capacity of the mixed chemistry battery.

### SUMMARY

In one exemplary embodiment, a method for balancing modules during charging of a mixed chemistry battery pack having a first battery module connected in series to a second battery module is provided. The method includes monitoring a first state-of-charge (SOC) of the first battery module having a first battery chemistry and monitoring a second SOC of the second battery module having a second battery chemistry that is different than the first battery chemistry. The method also includes selectively activating one of a first bypass switch and a first activation switch of the first battery module based on the first SOC and the second SOC and selectively activating one of a second bypass switch and a second activation switch of the second battery module based on the first SOC and the second SOC. Activation of the first bypass switch prevents the first battery module from charging and activation of the second bypass switch prevents the second battery module from charging.

In addition to the one or more features described herein the first chemistry is nickel-manganese cobalt and the second chemistry is lithium iron phosphate.

In addition to the one or more features described herein the first bypass switch and the second bypass switch are deactivated and the first activation switch and the second activation switch are activated based on a determination that the first SOC and the second SOC are less than one.

In addition to the one or more features described herein the first bypass switch and the second bypass switch are activated and the first activation switch and the second activation switch are deactivated based on a determination that the first SOC and the second SOC are equal to one.

In addition to the one or more features described herein the first activation switch is activated, the first bypass switch is deactivated, the second activation switch is deactivated, and the second bypass switch is activated based on a determination that the first SOC is less than one and the second SOC is equal to one.

In addition to the one or more features described herein the first activation switch is deactivated, the first bypass switch is activated, the second activation switch is activated, and the second bypass switch is deactivated based on a determination that the second SOC is less than one and the first SOC is equal to one.

In addition to the one or more features described herein the selective activation of the first bypass switch, the first activation switch, the second bypass switch, and the second activation switch are based on a flag value that is calculated based on the first SOC, a first capacity of the first battery module, the second SOC, a second capacity of the second battery module, and a capacity difference of the first battery module and the second battery module.

In one exemplary embodiment, a vehicle having a mixed chemistry battery is provided. The mixed chemistry includes a first battery cell having a first chemistry and a first activation switch connected to the first battery cell, wherein activation of the first activation switch enables charging of the first battery module. The mixed chemistry battery also includes a first bypass switch connected to the first battery cell, wherein activation of the first bypass switch prevents the first battery module from charging and a second battery connected to the first battery cell in series, the second battery cell having a second chemistry that is different than the first chemistry. The mixed chemistry battery further includes a second activation switch connected to the second battery cell, wherein activation of the second activation switch enables charging of the second battery module and a second bypass switch connected to the second battery cell, wherein activation of the second bypass switch prevents the second battery module from charging. The mixed chemistry battery also includes a controller configured to monitor a first state-of-charge (SOC) of the first battery cell and a second SOC of the second battery cell, selectively activate one of the first bypass switch and the first activation switch based on the first SOC and the second SOC, and selectively activate one of the second bypass switch and the second activation switch based on the first SOC and the second SOC.

In addition to the one or more features described herein the first chemistry is nickel-manganese cobalt and the second chemistry is lithium iron phosphate.

In addition to the one or more features described herein the first bypass switch and the second bypass switch are deactivated and the first activation switch and the second activation switch are activated by the controller based on a determination that the first SOC and the second SOC are less than one.

In addition to the one or more features described herein the first bypass switch and the second bypass switch are activated and the first activation switch and the second activation switch are deactivated by the controller based on a determination that the first SOC and the second SOC are equal to one.

In addition to the one or more features described herein the first activation switch is activated, the first bypass switch is deactivated, the second activation switch is deactivated, and the second bypass switch is activated by the controller based on a determination that the first SOC is less than one and the second SOC is equal to one.

In addition to the one or more features described herein the first activation switch is deactivated, the first bypass switch is activated, the second activation switch is activated, and the second bypass switch is deactivated by the controller based on a determination that the second SOC is less than one and the first SOC is equal to one.

In addition to the one or more features described herein the selective activation of the first bypass switch, the first activation switch, the second bypass switch, and the second activation switch are based on a flag value that is calculated based on the first SOC, a first capacity of the first battery module, the second SOC, a second capacity of the second battery module, and a capacity difference of the first battery module and the second battery module.

In one exemplary embodiment, a vehicle having a mixed chemistry battery is provided. The mixed chemistry includes a first battery cell having a first chemistry and a first discharge switch connected to the first battery cell and to a first resister, wherein activation of the first discharge switch causes dissipation of charge from the first battery module. The mixed chemistry battery also includes a second battery connected to the first battery cell in series, the second battery cell having a second chemistry that is different than the first chemistry and a second discharge switch connected to the second battery cell and to a second resister, wherein activation of the second discharge switch causes dissipation of charge from the second battery module. The mixed chemistry battery further includes a controller configured to monitor a first state-of-charge (SOC) of the first battery cell and a second SOC of the second battery cell and selectively activate the first discharge switch and the second discharge switch based on the first SOC and the second SOC.

In addition to the one or more features described herein the first chemistry is nickel-manganese cobalt and the second chemistry is lithium iron phosphate.

In addition to the one or more features described herein wherein the selective activation of the first bypass switch, the first activation switch, the second bypass switch, and the second activation switch are based on a flag value that is calculated by: Flag=(SOC₁·C₁−C_{D})−SOC₂·C₂ where SOC₁ is the first SOC, SOC₂ is the second SOC, C₁ is a total capacity of the first battery cell, C₂ is a total capacity of the second battery cell, and C_{D} is a difference between C₁ and C₂.

In addition to the one or more features described herein the first discharge switch is activated and the second discharge switch is deactivated by the controller based on a determination that the flag value is greater than zero.

In addition to the one or more features described herein the first discharge switch is deactivated and the second discharge switch is activated by the controller based on a determination that the flag value is less than zero.

In addition to the one or more features described herein the first discharge switch and the second discharge switch are deactivated by the controller based on a determination that the flag value is equal to zero.

The above features and advantages, and other features and advantages of the disclosure are readily apparent from the following detailed description when taken in connection with the accompanying drawings.

### BRIEF DESCRIPTION OF THE DRAWINGS

Other features, advantages, and details appear, by way of example only, in the following detailed description, the detailed description referring to the drawings in which:

FIG. 1 is a schematic diagram illustrating a vehicle having a mixed chemistry battery in accordance with an exemplary embodiment;

FIG. 2 is a block diagram illustrating a mixed chemistry battery in accordance with an exemplary embodiment;

FIG. 3 is a circuit diagram of a portion of a mixed chemistry battery in accordance with an exemplary embodiment;

FIG. 4 is a circuit diagram of a portion of another mixed chemistry battery in accordance with an exemplary embodiment;

FIG. 5 is a flowchart illustrating a method for balancing modules of a mixed chemistry in accordance with an exemplary embodiment;

FIG. 6 is a schematic illustration of a state-of-charge of battery modules of the mixed chemistry in accordance with an exemplary embodiment;

FIG. 7 is a flowchart illustrating a method for balancing modules of a mixed chemistry in accordance with an exemplary embodiment; and

FIG. 8 is a flowchart illustrating a method for balancing modules of a mixed chemistry in accordance with an exemplary embodiment.

### DETAILED DESCRIPTION

The following description is merely exemplary in nature and is not intended to limit the present disclosure, its application or uses. Various embodiments of the disclosure are described herein with reference to the related drawings. Alternative embodiments of the disclosure can be devised without departing from the scope of the claims. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship.

Turning now to an overview of the aspects of the disclosure, embodiments of the disclosure include a mixed chemistry battery having a first battery module and a second battery module that are connected in series. The first battery module includes lithium-ion battery cells that have a first chemistry, such as nickel manganese cobalt (NCM), nickel cobalt aluminum (NCA), lithium-ion manganese (LMO), lithium cobalt (LCO), or the like. The second battery module includes lithium-ion cells that have a second chemistry, such as lithium iron phosphate (LFP), lithium iron manganese phosphate (LFMP), sodium ion, or the like.

As discussed above, charge imbalances between battery modules of a mixed chemistry battery reduce the useable capacity of the mixed chemistry battery. In addition, charge imbalances increase the risk of overcharging or discharging the mixed chemistry battery. In exemplary embodiments, the mixed chemistry battery includes one or more activation switches and one or more bypass switches that are configured to selectively enable the charging of the different battery modules of the mixed chemistry battery.

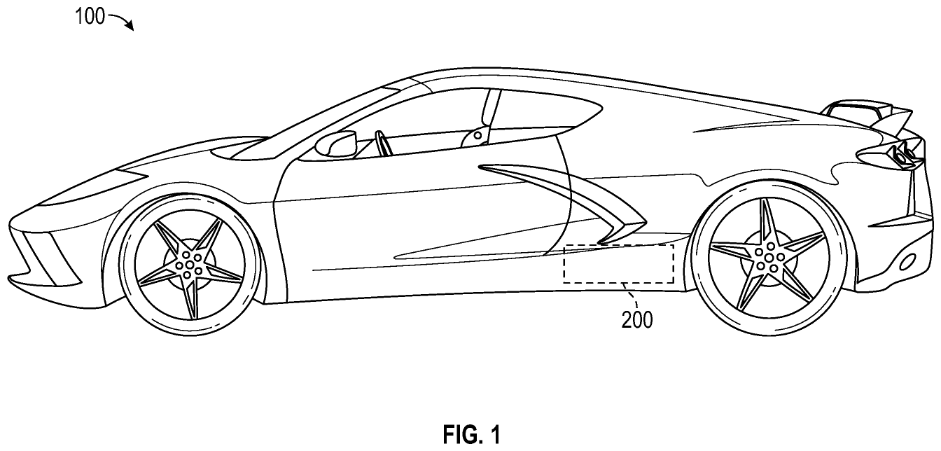

Referring now to FIG. 1, a schematic diagram of a vehicle 100 for use in conjunction with one or more embodiments of the present disclosure is shown. The vehicle 100 includes a mixed chemistry battery 200. In one embodiment, the vehicle 100 is a hybrid vehicle that utilizes both an internal combustion engine and an electric motor powered by the mixed chemistry battery 200. In another embodiment, the vehicle 100 is an electric vehicle that only utilizes electric motors that are powered by the mixed chemistry battery 200.

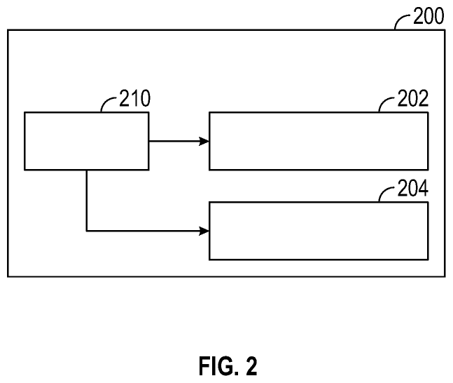

Referring now to FIG. 2 a mixed chemistry battery 200 in accordance with an exemplary embodiment is shown. The mixed chemistry battery 200 includes a first battery module 202 that is connected in series with a second battery module 204. In exemplary embodiments, the first battery module 202 is one of several battery modules in a series connection, each of which consists of a number of cells in the same chemistry, and the second battery module 204 is one of several battery modules in a series connection, each of which consists of a number of cells in another chemistry. The mixed chemistry battery 200 also includes a controller 210 that is configured to measure the charge of both the first battery module 202 and the second battery module 204 as well as the current that flows through the first battery module 202 and the second battery module 204. In some embodiments, the controller 210 is further configured to monitor the temperature of the first battery module 202 and the second battery module 204 and to perform state-of-charge (SOC) estimation-related functions.

In exemplary embodiments, the controller 210 includes one or more of a general processor, a central processing unit, an application-specific integrated circuit (ASIC), a digital signal processor, a field-programmable gate array (FPGA), a digital circuit, an analog circuit, or combinations thereof. In exemplary embodiments, the controller 210 is configured to calculate and track the SOC and SOH of both the first battery module 202 and the second battery module 204. In exemplary embodiments, the controller 210 is configured to selectively activate and deactivate one or more activation switches (not shown) and one or more bypass switches (not shown) that are configured to selectively enable the charging of the first battery module 202 and the second battery module 204.

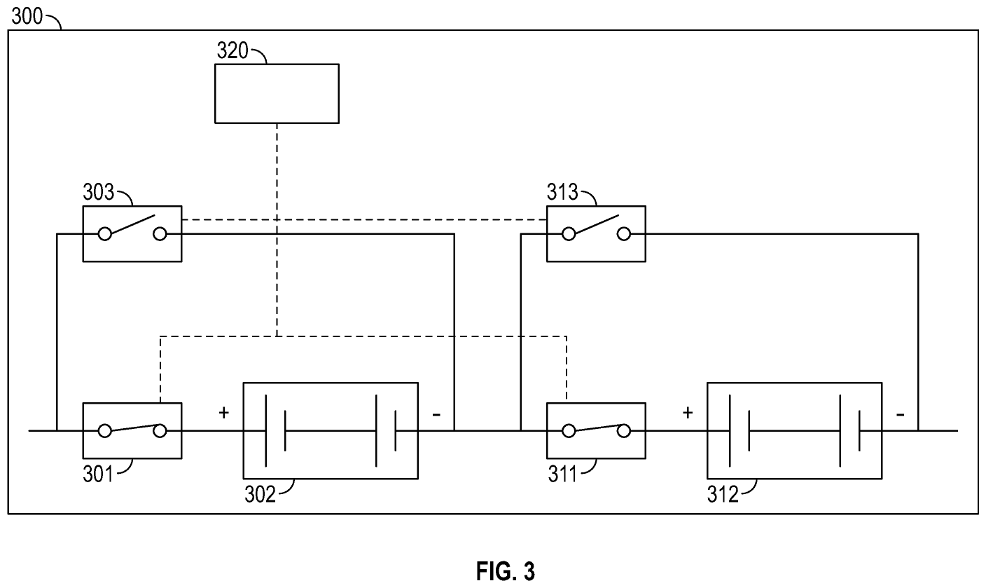

Referring now to FIG. 3 a circuit diagram of a portion a mixed chemistry battery 300 in accordance with an exemplary embodiment is shown. As illustrated, the mixed chemistry battery 300 includes a first battery module 302 and a second battery module 312 that are connected in series. The first battery module 302 is connected to a first activation switch 301 and a first bypass switch 303. Likewise, the second battery module 312 is connected to a second activation switch 311 and a second bypass switch 313. In exemplary embodiments, the mixed chemistry battery 300 includes a controller 320 that is configured to determine the SOC of the first battery module 302 and the second battery module 312. The controller 320 is further configured to control the operation of the first activation switch 301, the first bypass switch 303, the second activation switch 311, and the second bypass switch 313 during charging and discharging of the battery to ensure that the SOC of the first battery module 302 and the SOC of the second battery module 312 remain within a threshold difference of one another, (i.e., that the battery modules of the mixed chemistry battery 300 remain balanced).

While FIG. 3 only illustrates two battery modules, it will be appreciated by those of ordinary skill in the art that the mixed chemistry battery 300 may contain substantially more battery modules. In one embodiment, each battery module includes activation and bypass switches that are individually controlled by the controller 320. In another embodiment, the activation and bypass switches for each battery module having the same chemistry may be controlled as a group by the controller 320. For example, the controller will activate/deactivate the charging of all of the LFP battery modules together as a group.

In exemplary embodiments, the activation switches and bypass switches have diffident configurations. For example, the activation switches are configured to handle a large current (e.g., one to three coulombs) and bypass switches are configured to handle a relatively small current (e.g., one tenth of a coulomb), which is still much larger than traditional passive balancing current (e.g., 0.2A).

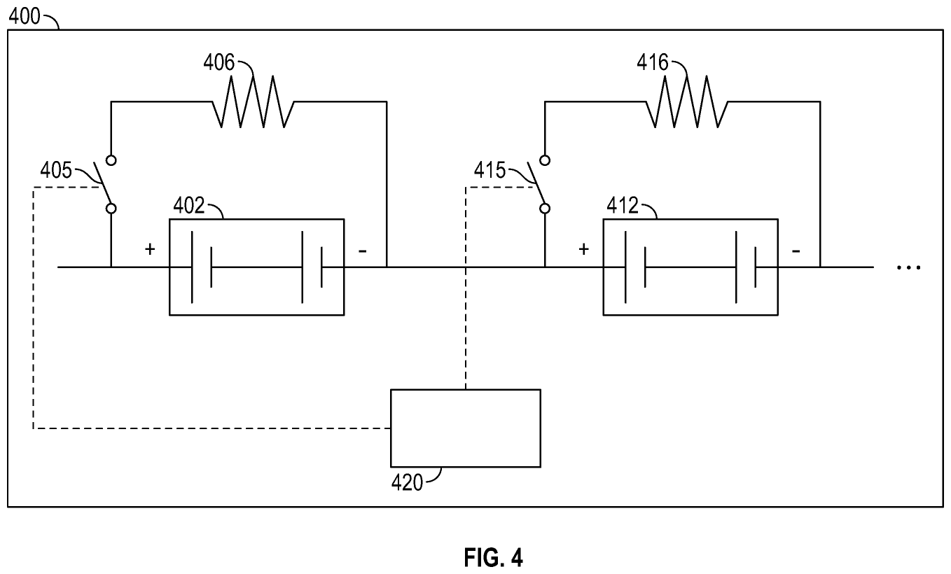

Referring now to FIG. 4 a circuit diagram of a portion a mixed chemistry battery 400 in accordance with an exemplary embodiment is shown. As illustrated, the mixed chemistry battery 400 includes a first battery module 402 and a second battery module 412 that are connected in series. The first battery module 402 is connected to a first discharge switch 405 and a first resister 406. Likewise, the second battery module 412 is connected to a second discharge switch 415 and a second resister 416. In exemplary embodiments, the mixed chemistry battery 400 includes a controller 420 that is configured to determine the SOC of the first battery module 402 and the second battery module 412. The controller 420 is further configured to control the operation of the first discharge switch 405 and the second discharge switch 415 during the charging and discharging of the battery to ensure that the SOC of the first battery module 402 and the SOC of the second battery module 412 remain within a threshold difference of one another, (i.e., that the battery modules of the mixed chemistry battery 400 remain balanced).

While FIG. 4 only illustrates two battery modules, it will be appreciated by those of ordinary skill in the art that the mixed chemistry battery 400 may contain substantially more battery modules. In one embodiment, each battery module includes a discharge switch that is individually controller by the controller 420. In another embodiment, the discharge switches for each battery module having the same chemistry may be controlled as a group by the controller 420. For example, the controller will activate/deactivate the charging of all of the LFP battery modules together as a group.

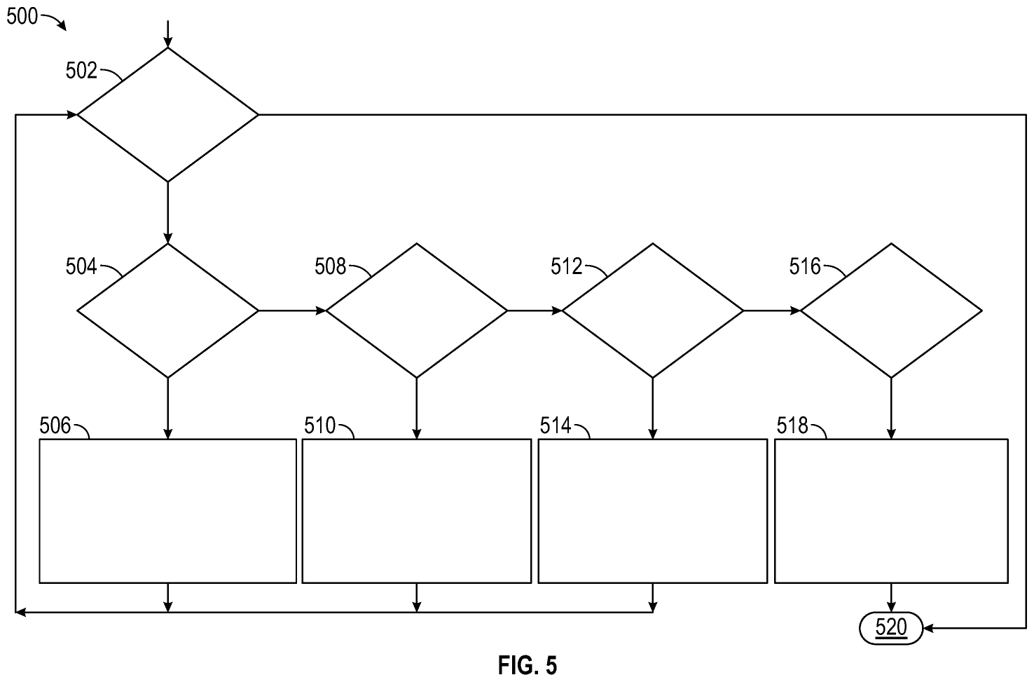

Referring now to FIG. 5, a flowchart illustrating a method 500 for charging a mixed chemistry battery in accordance with an exemplary embodiment is shown. In exemplary embodiments, the method 500 is performed by a controller 320, such as the one shown in FIG. 3. The method begins at decision block 502 by determining if the mixed chemistry battery is in a charging mode. If the mixed chemistry battery is not in a charging mode, the method 500 proceeds to block 520 and ends. Otherwise, if the mixed chemistry battery is in a charging mode, the method 500 proceeds to decision block 504 and determines if the SOC of a first battery module and the SOC of a second battery module, having different battery chemistries, are less than one, (i.e., neither of the battery modules are fully charged). If neither of the battery modules are fully charged, the method 500 proceeds to block 506 and the activation switches associated with both battery modules are activated and the bypass switches associated with both battery modules are deactivated, which permits fast charging of both battery modules. For example, in the fast-charging mode a first current level of one coulomb (1C) may be provided to both battery modules.

If at least one of the battery modules is fully charged, the method 500 proceeds to decision block 508 and determines if the SOC of the first battery module is less than one and the SOC of the second battery module is equal to one, (i.e., the second battery module is fully charged and the first battery module is not fully charged). If the second battery module is fully charged and the first battery module is not fully charged, the method 500 proceeds to block 510, and the activation switches associated with the first battery module are activated, the bypass switches associated with the first battery module are deactivated, the activation switches associated with the second battery module are deactivated, the bypass switches associated with the second battery module are deactivated, which only permits charging of the first battery module.

At decision block 512, the method 500 includes determining whether the SOC of the second battery module is less than one and the SOC of the first battery module is equal to one, (i.e., the first battery module is fully charged and the second battery module is not fully charged). If the first battery module is fully charged and the second battery module is not fully charged, the method 500 proceeds to block 514, and the activation switches associated with the second battery module are activated, the bypass switches associated with the second battery module are deactivated, the activation switches associated with the first battery module are deactivated, the bypass switches associated with the first battery module are deactivated, which only permits charging of the second battery module.

In exemplary embodiments, at block 510 and at block 514 the mixed chemistry battery is operating in a charge balancing mode that only provides a second level of current to one of the battery modules, where the second level of current is less that the first current level provided in the fast-charging mode. For example, in the charge balancing mode the second current level may be one tenth of a coulomb (0.1C).

At decision block 516, the method 500 includes determining whether the SOC of the first battery module and the SOC of the second battery module are equal to one, (i.e., both the first battery module and second battery module are fully charged). If both the first battery module and second battery module are fully charged, the method 500 proceeds to block 518, and the activation switches associated with both battery modules are activated and the bypass switches associated with both battery modules are deactivated, which permits discharging of both battery modules simultaneously.

In exemplary embodiments, whenever a discharge state is detected, all activation switches are activated to provide the required voltage and power. For example, in once case when the battery cells are not fully charged, the operator of the vehicle may unplug and use his vehicle. In this embodiment, the controller conducts large current simultaneous charging first, then conduct the low current balancing.

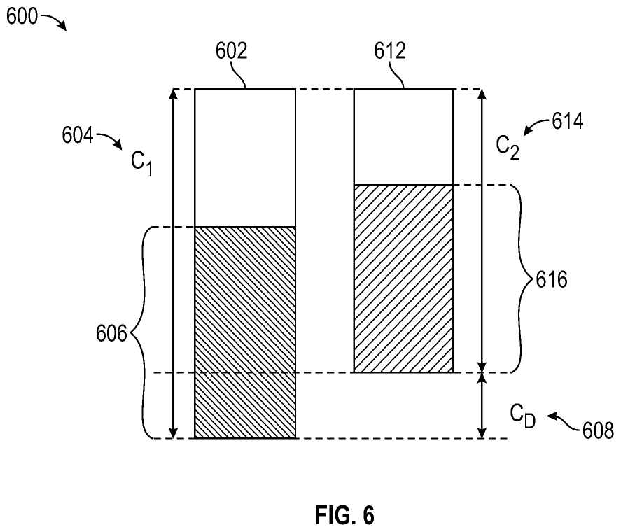

Referring now to FIG. 6 a schematic illustration of the state-of-charge of cells of a mixed chemistry battery 600 in accordance with an exemplary embodiment is shown. As illustrated, a first battery module 602, which has a first chemistry, has a first capacity (C₁) 604, and a second battery module 614, which has a second chemistry that is different that the first chemistry, has a second capacity (C₂) 614. In one embodiment, the first battery module 602 includes NCM cells and the second battery module 612 includes LFP cells. The first nominal capacity (C₁) 604 is larger than the second nominal capacity (C₂) 614 by a capacity difference (Ca) 608. The first battery module has a first state-of-charge (SOC₁) 606 and the second battery module has a second state-of-charge (SOC₂) 616. In exemplary embodiments, these measurements of the capacity and SOC of the battery modules are used to calculate a flag value that is used to control the operational state (i.e., activated or deactivated) of one or more of the activation, bypass, and discharge switches. In one embodiment, the flag value is calculated as:

$$Flag = ( S O {C}_{1} \cdot {C}_{1} - {C}_{D} ) - S O {C}_{2} \cdot {C}_{2} .$$

Returning to FIG. 4, based on a determination by the controller 420 that the flag value is less than zero, the first discharge switch 405 is deactivated and the second discharge switch 415 is activated. Based on a determination by the controller 420 that the flag value is greater than zero, the first discharge switch 405 is activated and the second discharge switch 415 is deactivated. Furthermore, based on a determination by the controller 420 that the flag value is equal to zero, the first discharge switch 405 and the second discharge switch 415 are deactivated.

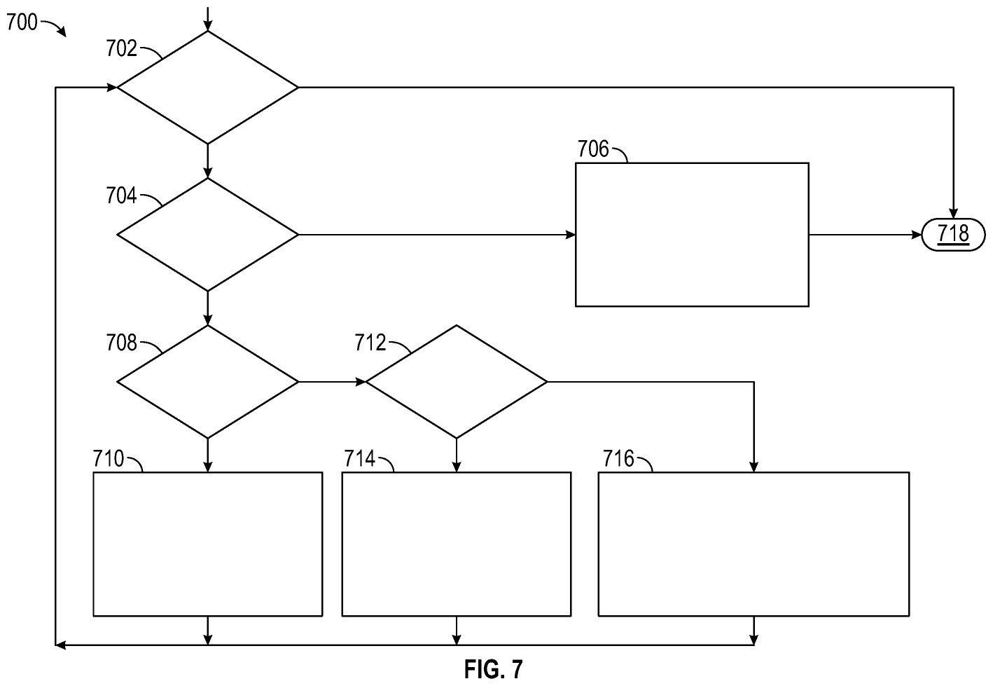

Referring now to FIG. 7, a flowchart illustrating a method 700 for balancing modules of a mixed chemistry in accordance with an exemplary embodiment is shown. In exemplary embodiments, the method 700 is performed by a controller 320, such as the one shown in FIG. 3. The method 700 begins at block 702 by determining if the mixed chemistry battery is in a charging mode. If the mixed chemistry battery is not in a charging mode, the method 700 proceeds to block 718 and ends. Otherwise, if the mixed chemistry battery is in a charging mode, the method 700 proceeds to decision block 704 and determines if the SOC of a first battery module and the SOC of a second battery module are equal to one, (i.e., both of the battery modules are fully charged). Based on a determination that both of the battery modules are fully charged, the method proceeds to block 706 and the bypass switches for both the first battery module and the second battery module are deactivated and the activation switches for both the first battery module and the second battery module are activated, which permits discharging of the mixed chemistry battery.

Based on a determination that both of the battery modules are not fully charged, the method proceeds to decision block 708 and a determination is made of whether the flag value is less than zero. Based on a determination that the flag value is less than zero, the method 700 proceeds to block 710, and the activation switches associated with the first battery module are activated, the bypass switches associated with the first battery module are deactivated, the activation switches associated with the second battery module are deactivated, the bypass switches associated with the second battery module are deactivated, which only permits charging of the first battery module.

Based on a determination that the flag value is not less than zero, the method 700 proceeds to decision block 712. At decision block 712, a determination is made of whether the flag value is greater than zero. Based on a determination that the flag value is greater than zero, the method 700 proceeds to block 714, and the activation switches associated with the second battery module are activated, the bypass switches associated with the second battery module are deactivated, the activation switches associated with the first battery module are deactivated, the bypass switches associated with the first battery module are deactivated, which only permits charging of the second battery module.

Based on a determination that the flag value is not greater than zero, the method 700 proceeds to block 716 and the activation switches associated with both battery modules are activated and the bypass switches associated with both battery modules are deactivated, which permits charging of both battery modules simultaneously. In this embodiment, the controller conducts the low current balancing first, and then conduct the large current simultaneous charging. While this embodiment may require a longer charging time, it will guarantee a balanced state of LFP and NCM module and would be beneficial for battery pack lifespan and SOC estimation accuracy.

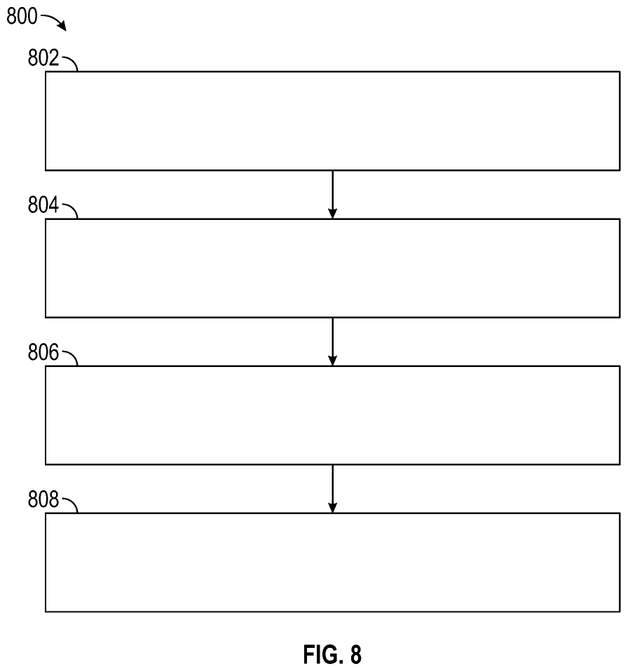

Referring now to FIG. 8, a flowchart illustrating a method 800 for charging a mixed chemistry battery in accordance with an exemplary embodiment is shown. In exemplary embodiments, the method 800 is performed by a controller 210, such as the one shown in FIG. 2. At block 802, the method 800 includes monitoring a first state-of-charge (SOC) of the first battery module having a first battery chemistry. Next, as at block 804, the method 800 includes monitoring a second SOC of the second battery module having a second battery chemistry, which is different than the first battery chemistry. In exemplary embodiments, the first chemistry is nickel-manganese cobalt and the second chemistry is lithium-iron phosphate.

At block 806, the method 800 includes selectively activating one of a first bypass switch and a first activation switch of the first battery module based on the first SOC and the second SOC. Next, at block 808, the method 800 includes selectively activating one of a second bypass switch and a second activation switch of the second battery module based on the first SOC and the second SOC. In exemplary embodiments, only one of the bypass switch and the activation switch associated with a battery module may be activated at the same time.

In one embodiment, the first bypass switch and the second bypass switch are deactivated and the first activation switch and the second activation switch are activated based on a determination that the first SOC and the second SOC are less than one. In another embodiment, the first bypass switch and the second bypass switch are activated and the first activation switch and the second activation switch are deactivated based on a determination that the first SOC and the second SOC are equal to one. In one embodiment, the first activation switch is activated, the first bypass switch is deactivated, the second activation switch is deactivated, and the second bypass switch is activated based on a determination that the first SOC is less than one and the second SOC is equal to one. In another embodiment, the first activation switch is deactivated, the first bypass switch is activated, the second activation switch is activated, and the second bypass switch is deactivated based on a determination that the second SOC is less than one and the first SOC is equal to one.

In exemplary embodiments, the selective activation of the first bypass switch, the first activation switch, the second bypass switch, and the second activation switch are based on a flag value that is calculated based on the first SOC, a first capacity of the first battery module, the second SOC, a second capacity of the second battery module, and a capacity difference of the first battery module and the second battery module.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method for balancing modules during charging of a mixed chemistry battery pack having a first battery module connected in series to a second battery module, the method comprising:
monitoring a first state-of-charge (SOC) of the first battery module having a first battery chemistry;
monitoring a second SOC of the second battery module having a second battery chemistry that is different than the first battery chemistry;
selectively activating one of a first bypass switch and a first activation switch of the first battery module based on the first SOC and the second SOC; and
selectively activating one of a second bypass switch and a second activation switch of the second battery module based on the first SOC and the second SOC, wherein activation of the first bypass switch prevents the first battery module from charging and activation of the second bypass switch prevents the second battery module from charging.

2. The method of claim 1, wherein the first battery chemistry is nickel-manganese cobalt and the second battery chemistry is lithium iron phosphate.

3. The method of claim 1, wherein the first bypass switch and the second bypass switch are deactivated and the first activation switch and the second activation switch are activated based on a determination that the first SOC and the second SOC are less than one.

4. The method of claim 1, wherein the first bypass switch and the second bypass switch are activated and the first activation switch and the second activation switch are deactivated based on a determination that the first SOC and the second SOC are equal to one.

5. The method of claim 1, wherein the first activation switch is activated, the first bypass switch is deactivated, the second activation switch is deactivated, and the second bypass switch is activated based on a determination that the first SOC is less than one and the second SOC is equal to one.

6. The method of claim 1, wherein the first activation switch is deactivated, the first bypass switch is activated, the second activation switch is activated, and the second bypass switch is deactivated based on a determination that the second SOC is less than one and the first SOC is equal to one.

7. The method of claim 1, wherein the selective activation of the first bypass switch, the first activation switch, the second bypass switch, and the second activation switch are based on a flag value that is calculated based on the first SOC, a first capacity of the first battery module, the second SOC, a second capacity of the second battery module, and a capacity difference of the first battery module and the second battery module.

8. A vehicle comprising:
a mixed chemistry battery comprising:
a first battery cell having a first chemistry;
a first activation switch connected to the first battery cell, wherein activation of the first activation switch enables charging of the first battery cell;
a first bypass switch connected to the first battery cell, wherein activation of the first bypass switch prevents the first battery cell from charging;
a second battery cell connected to the first battery cell in series, the second battery cell having a second chemistry that is different than the first chemistry;
a second activation switch connected to the second battery cell, wherein activation of the second activation switch enables charging of the second battery cell;
a second bypass switch connected to the second battery cell, wherein activation of the second bypass switch prevents the second battery cell from charging; and
a controller configured to:
monitor a first state-of-charge (SOC) of the first battery cell and a second SOC of the second battery cell;
selectively activate one of the first bypass switch and the first activation switch based on the first SOC and the second SOC; and
selectively activate one of the second bypass switch and the second activation switch based on the first SOC and the second SOC.

9. The vehicle of claim 8, wherein the first chemistry is nickel-manganese cobalt and the second chemistry is lithium iron phosphate.

10. The vehicle of claim 8, wherein the first bypass switch and the second bypass switch are deactivated and the first activation switch and the second activation switch are activated by the controller based on a determination that the first SOC and the second SOC are less than one.

11. The vehicle of claim 8, wherein the first bypass switch and the second bypass switch are activated and the first activation switch and the second activation switch are deactivated by the controller based on a determination that the first SOC and the second SOC are equal to one.

12. The vehicle of claim 8, wherein the first activation switch is activated, the first bypass switch is deactivated, the second activation switch is deactivated, and the second bypass switch is activated by the controller based on a determination that the first SOC is less than one and the second SOC is equal to one.

13. The vehicle of claim 8, wherein the first activation switch is deactivated, the first bypass switch is activated, the second activation switch is activated, and the second bypass switch is deactivated by the controller based on a determination that the second SOC is less than one and the first SOC is equal to one.

14. The vehicle of claim 8, wherein the selective activation of the first bypass switch, the first activation switch, the second bypass switch, and the second activation switch are based on a flag value that is calculated based on the first SOC, a first capacity of the first battery cell, the second SOC, a second capacity of the second battery cell, and a capacity difference of the first battery cell and the second battery cell.

15. A vehicle comprising:
a mixed chemistry battery comprising:
a first battery cell having a first chemistry;
a first discharge switch connected to the first battery cell and to a first resister, wherein activation of the first discharge switch causes dissipation of charge from the first battery cell;
a second battery cell connected to the first battery cell in series, the second battery cell having a second chemistry that is different than the first chemistry;
a second discharge switch connected to the second battery cell and to a second resister, wherein activation of the second discharge switch causes dissipation of charge from the second battery cell; and
a controller configured to:
monitor a first state-of-charge (SOC) of the first battery cell and a second SOC of the second battery cell;
selectively activate the first discharge switch and the second discharge switch based on the first SOC and the second SOC.

16. The vehicle of claim 15, wherein the first chemistry is nickel-manganese cobalt and the second chemistry is lithium iron phosphate.

17. The vehicle of claim 15, wherein the selective activation of a first discharge switch and the second discharge switch are based on a flag value that is calculated by:
$$Flag = ( S O {C}_{1} \cdot {C}_{1} - {C}_{D} ) - S O {C}_{2} \cdot {C}_{2}$$
where SOC₁ is the first SOC, SOC₂ is the second SOC, C₁ is a total capacity of the first battery cell, C₂ is a total capacity of the second battery cell, and C_{D} is a difference between C₁ and C₂.

18. The vehicle of claim 17, wherein the first discharge switch is activated and the second discharge switch is deactivated by the controller based on a determination that the flag value is greater than zero.

19. The vehicle of claim 17, wherein the first discharge switch is deactivated and the second discharge switch is activated by the controller based on a determination that the flag value is less than zero.

20. The vehicle of claim 17, wherein the first discharge switch and the second discharge switch are deactivated by the controller based on a determination that the flag value is equal to zero.
